(19) United States
(12) Patent Application Publication
(10) Pub. No.: US 2005/0100737 A1
(43) Pub. Date: May 12, 2005

(54) Cyclohexyl silyl or phenyl silyl substituted poly (phenylenevinylene) derivative, electroluminescence device using the same and production method thereof

(76) Inventors: Hong Ku Shim, Daejeon (KR); Taek Ahn, Daejeon (KR); Seoung won Ko, Daejeon (KR); Jae Min Lee, Daejeon (KR); Jong Chul Kim, Daejeon (KR)

Correspondence Address: MARTINE PENILLA & GENCARELLA, LLP, 710 LAKEWAY DRIVE, SUITE 200, SUNNYVALE, CA, 94085, US

(21) Appl. No.: 10/484,649

(22) PCT Filed: Jul. 22, 2002
(86) PCT No.: PCT/KR02/01376

(30) Foreign Application Priority Data
Jul. 23, 2001 (KR) 2001-44307

(51) Int. Cl. B32B 15/04; C08G 77/00

(52) U.S. Cl. 428/411.1; 428/457; 528/40; 528/43

(57) ABSTRACT

Disclosed is a luminescent polymer applicable to various electroluminescence devices, and more specifically, a novel poly(p-phenylvinylene) derivative with cyclohexyl or phenyl substituted silyl group on the side chain thereof, represented by the following formula 1. The luminescent polymer is excellent in thermal properties and luminance efficiency, and radiates at a green light wavelength range due to electronic properties of the silyl substituent, thus serving as an electroluminescence device material. 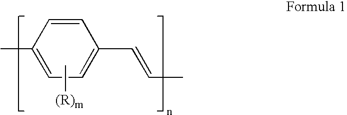 wherein R is a cyclohexyl or phenyl substituted silyl group; and m is an integer of 1-4.

### TECHNICAL FIELD

The present invention pertains, in general, to luminescent polymers applicable for various electroluminescence devices. More specifically, the present invention discloses a novel poly(p-phenylenevinylene) derivative having a cyclohexyl or phenyl substituted silyl group on the side chain thereof.

### PRIOR ART

Typically, light-emitting materials useful in polymeric electroluminescence devices are exemplified by conjugated polymers, such as poly(1,4-phenylenevinylene) (PPV), poly(para-phenylene) (PPP), polythiophene (PT), polyfluorene (PF), etc. Of them, PPV and derivatives thereof have been widely used as the electroluminescence device materials. PPV is used as not only a light-emitting layer but also a hole transporting layer in a multi-layer film device due to its good hole transportability.

In particular, there has been increasing interest in the silyl substituted PPV derivatives since poly[2-(3-epi-cholestanol)-5-dimethylthesylsilyl-1,4-phenylenevinylene](CS-PPV) was reported by Wudl et al. Silyl substituted PPVs have many valuable properties, for instance, high photoluminescence quantum efficiency, excellent solubility and uniform film morphology. Although alkylsilyl or alkoxy substituted PPV used up to the present has excellent solubility, it tends to have lower glass transition temperature (T_{g}) than PPV.

An operation lifetime of the electroluminescence device is directly related with glass transition temperature and thermal stability of the polymer used in the light-emitting layer. Hence, there is an urgently recognized need for development of polymers having excellent mechanical strength (high T_{g}) as well as high solubility.

### DISCLOSURE OF THE INVENTION

Aiming to overcome limitations of conventional PPVs and derivatives thereof, we, the inventors of the present invention, have been trying to develop a novel PPV derivative having good light-emitting properties, such as excellent mechanical strength (high T_{g}) and solubility.

Accordingly, it is an object of the present invention to provide a novel luminescent polymer suitable for use in an electroluminescence device, which emits light at a green light wavelength range due to electronic properties of a silyl substitutent, while exhibiting excellent thermal properties and luminance efficiency.

It is another object of the present invention to provide a method of producing such a luminescent polymer.

It is a further object of the present invention to provide an electroluminescence device comprising a polymer light-emitting layer formed with the luminescent polymer.

### BRIEF DESCRIPTION OF THE DRAWINGS

FIG. 1 is a reaction scheme showing a preparation process of the luminescent polymer of the present invention.

FIG. 2 is a schematic diagram showing a configuration of an electroluminescence device comprising the luminescent polymer of the present invention applied to a polymer light-emitting layer.

FIG. 3 is a graph showing the weight of the luminescent polymer of the present invention according to thermogravimetry.

FIG. 4 is a graph showing the heat flow of the luminescent polymer of the present invention according to differential scanning calorimetry (DSC).

FIG. 5 is a graph showing the UV absorption spectrum of the luminescent polymer of the present invention.

FIG. 6 is a graph showing the photoluminescence (PL) spectrum of the luminescent polymer of the present invention.

FIG. 7 is a graph showing the current of the luminescent polymer of the present invention according to cyclic voltammetry (CV).

FIG. 8 is a graph showing the electroluminescence (EL) spectrum obtained from the EL device comprising ITO/polymer light-emitting layer/Al electrode layer.

FIG. 9a is a graph showing the current-voltage curve of each of a single-layer electroluminescence device comprising an ITO/polymer light-emitting layer/Al electrode layer and a double-layer EL device comprising an ITO/PVK/polymer light-emitting layer/Al electrode layer.

FIG. 9b is a graph showing the luminance density-voltage curve of each of a single-layer EL device comprising an ITO/polymer light-emitting layer/Al electrode layer and a double-layer EL device comprising an ITO/PVK/polymer light-emitting layer/Al electrode layer.

FIG. 10a is a graph showing the external quantum efficiency of each of the single-layer and the double-layer EL devices according to the present invention.

FIG. 10b is a graph showing the power efficiency of each of the single-layer and the double-layer EL devices according to the present invention.

FIG. 11 is a graph showing the current-luminance density-voltage curve of the multi-layer EL device according to the present invention.

### BEST MODES FOR CARRYING OUT THE INVENTION

A luminescent polymer of the present invention is represented by the following formula 1: 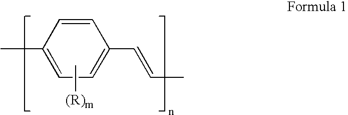
Wherein R is a cyclohexyl or phenyl substituted silyl group; and m is an integer of 1-4.

The luminescent polymer of the present invention is characterized by a completely conjugated structure comprising a phenylene backbone and an ethylene bridge alternately formed in succession.

In the above formula 1, the value ‘n’ can be varied as necessary by those skilled in this art, and is not specifically limited. However, in order to exhibit various properties including mechanical properties, it is preferred that the value falls in the range of 3,000 or smaller.

The silyl group introduced to the side chain of the luminescent polymer represented by the formula 1, includes, but is not limited to, cyclohexyl or phenyl substituents as well as C1 to C20 linear or branched alkyl groups.

Different from conventional polymers having alkyl or alkoxy groups, the luminescent polymer of the formula 1 has the cyclohexyl or phenyl substituted silyl group, and thus can emit light in a green wavelength range. This green shift results from the electronic properties of the silyl group, which has a weak electron-donating effect, and the greater steric hindrance of the bulky cyclohexyl silyl and phenyl silyl groups which break the coplanarity of the polymer main chain. With a view to improving a photoluminescence efficiency and electroluminescence performance, the polymer should be excellent in solubility and mechanical properties including glass transition temperature and thermal stability. Particularly, the operation lifetime of the electroluminescence device has a direct relation to the glass transition temperature (Tg) and thermal stability of the polymers used. As for the luminescent polymer of the present invention, incorporation of cyclohexyl or phenyl substituted silyl group to the polymer side chain considerably suppresses the flexibility of the polymer and thus increases the glass transition temperature of the polymer.

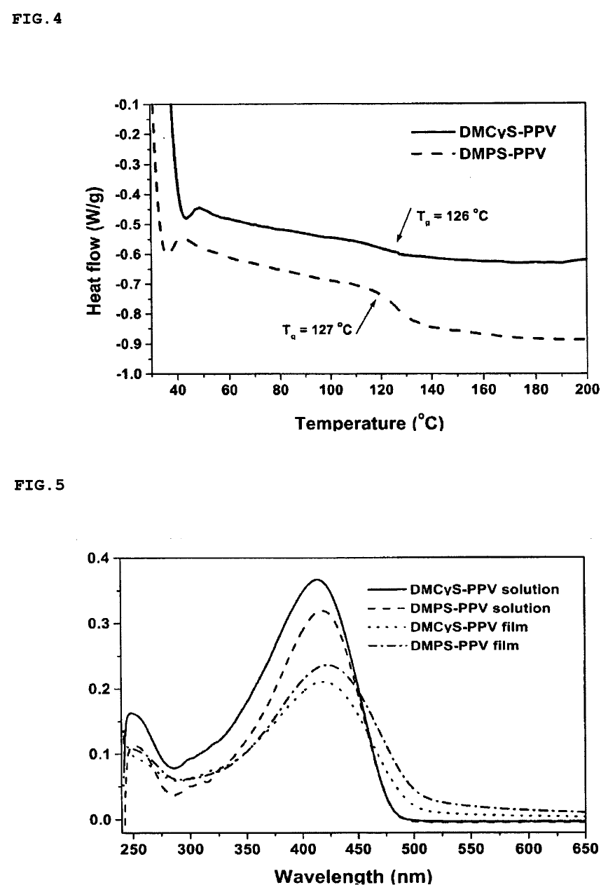

Included in the group of the luminescent polymer of the formula 1, poly[{2-(dimethylcyclohexylsilyl)-1,4-phenylenevinylene}] (hereinafter, abbreviated to DMCyS-PPV) and poly[{2-(dimethylphenylsilyl)-1,4-phenylenevinylene}] (hereinafter, abbreviated to DMPS-PPV) have glass transition temperatures of 126° C. and 127° C., respectively, and thus are superior in mechanical properties to other luminescent polymers (see, FIG. 4).

In addition, thermal stability of the luminescent polymers (DMCyS-PPV and DMPS-PPV), measured by thermogravimetry, shows weight loss of 5% or less at 400° C. Hence, it can be seen that the inventive polymer is more stable, compared to conventional luminescent polymers (see, FIG. 3).

The luminescent polymer of the formula 1 with mechanical properties can be completely dissolved in a general organic solvent on account of the presence of silyl groups. As such, the usable organic solvent is exemplified by chloroform, chlorobenzene, tetrahydrofuran (THF), 1,2-dichloroethane, toluene and so on.

Therefore, the polymers of the present invention can exhibit high luminance properties in solution or solid film.

Amorphia of the film required for improvement of photoluminescence performance can be easily achieved through the inventive luminescent polymer of the formula 1. That is to say, since the luminescent polymer contains cyclohexyl or phenyl silyl substitutents of large bulky volume in comparison to other alkoxy or n-alkyl group substituted luminescent polymers, the planarity of the polymer main chain is decreased and thus the packing of the polymer chain is further hindered, thereby easily fabricating an amorphous polymer film.

In terms of quantum efficiency, the solution phase polymer is much better than or equal to conventional poly(p-phenylenevinylene) or polyfluorene having alkoxy and alkyl group side chains. The solid film phase polymer also has more desirable properties in comparison to conventional poly(p-phenylenevinylene) derivatives.

The luminescent polymer of the formula 1, which is excellent in electron acceptability and transportability, has superior electroluminescence performance to conventional luminescent polymers having alkoxy side chain.

The luminescent polymer of the present invention represented by the formula 1 is polymerized from a monomer compound represented by the following formula 2. 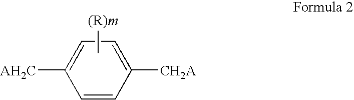
wherein, R is a cyclohexyl or phenyl substituted silyl group; m is an integer of 1-4; and A is a halogen element.

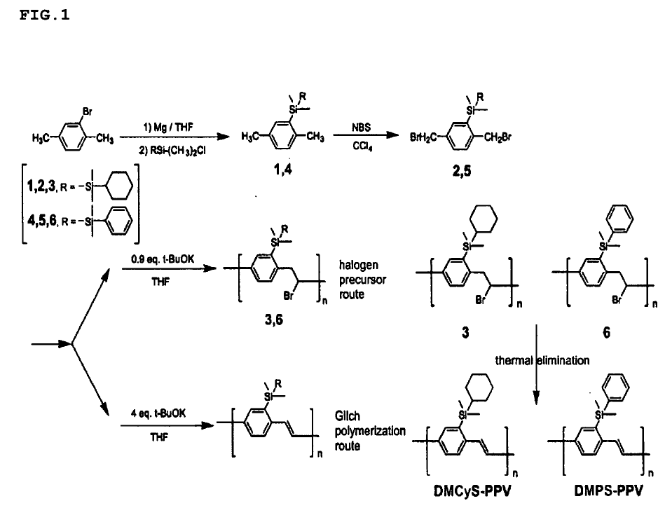

Referring to FIG. 1, there is shown a preparation process of DMCyS-PPV and DMPS-PPV as a preferable embodiment of the luminescent polymer.

2-bromo-p-xylene is first reacted with chlorodimethyl cyclohexylsilane to produce 2-dimethylcyclohexylsilyl-p-xylene 1 (or 2-dimethylphenylsilyl-p-xylene 4) as an intermediate, which is then brominated, yielding 2-dimethylcyclohexylsilyl-1,4-bis(bromomethyl) benzene 2 (or 2-dimethylphenylsilyl-1,4-bis(bromomethyl)benzene 5), as the monomer.

Then, thusly obtained monomer can be polymerized using halogen precursor route or Gilch polymerization (dehydrohalogenation). When the halogen precursor route is adopted, an additional subsequent process for thermal elimination is required. Meanwhile, in the case of adopting the Gilch polymerization method, the luminescent polymer represented by the formula 1 can be directly prepared.

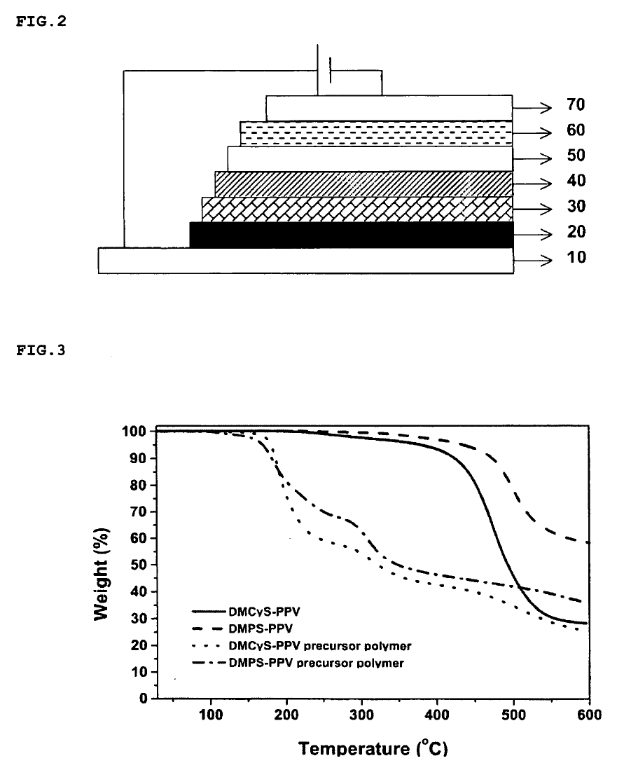

Further, the present invention provides an electroluminescence device comprising the above luminescent polymer of the formula 1 applied to a predetermined polymer light-emitting layer. As for the EL device shown in FIG. 2, there are a single-layer EL device comprising, on a substrate 10, a semitransparent electrode layer 20, the polymer light-emitting layer 50 and a metal electrode layer 70 in order, or a multi-layer EL device for maximizing electroluminescent efficiency (balanced injection of hole and electron) further comprising a hole injecting layer 30 and an electron injecting layer 60 for easily performing injection of holes and electrons.

The hole injecting layer 30 functions to improve performance of the electroluminescence device, and can be formed with poly(styrenesulfonic acid) (PSS) doped poly(3,4-ethyleneoxythiophene) (PEDOT).

The electron injecting layer 60 acts as an insulating layer that decreases an electron injecting barrier to electron injection from the metal electrode 70 to polymer LUMO, and can be formed with LiF-containing alkali metal compounds.

In the electroluminescence device of FIG. 2, a relatively high energy barrier exists between the semitransparent electrode layer 20 (or hole injecting layer 30) and HOMO of the luminescent polymer constituting the polymer light-emitting layer 50, thus electron or hole transportability is restrained.

In order to alleviate such restriction, the luminescent polymer is blended with a certain electron or hole transporting polymer, to form the polymer light-emitting layer 50, which is contained in the device. Also, the electroluminescence device contains a hole transporting layer 40 introduced between the hole injecting layer 30 or the semitransparent electrode layer 20 and the polymer light-emitting layer. As the hole transporting polymer, poly(9-vinylcarbazol) (PVK) is preferably used.

A better understanding of the present invention may be obtained in light of the following examples which are set forth to illustrate, but are not to be construed to limit the present invention.

### EXAMPLE 1

### Preparation of 2-Dimethylcyclohexylsilyl-p-xylene (5)

2-bromo-p-xylene (10.0 g, 54.0 mmol) in absolute THF was activated with 5 mol % 1,2-dibromoethane at 80° C., and slowly added with clean magnesium turnings (2.27 g, 93.5 mmol). When the magnesium turnings were completely consumed, chlorodimethylcyclohexylsilane (13.4 ml, 71.5 mmol) was added thereto. The reaction mixture was heated to reflux for 6 hours, and the reaction was quenched with dilute aqueous hydrochloric acid solution. THF layer was separated and washed several times with water, while the solvent was removed using a rotary evaporator. The residue was vacuum distilled to give a colorless liquid product (yield: 38%, 5.2 g).

¹H-NMR (CDCl₃, ppm): 7.23 (m, 1H), 7.06 (m, 2H), 2.4 (s, 3H), 2.3 (s, 3H), 1.72-1.61 (m, 5H), 1.28-1.08 (m, 6H); ¹³C-NMR (CDCl₃, ppm): 140.43, 136.60, 135.79, 133.72, 129.66, 128.89, 28.19, 27.71, 26.95, 25.72, 22.84, 21.10, −3.75. Anal. Calcd for C₁₆H₂₆Si: C, 77.97; H, 10.63. Found: C, 77.23; H, 9.89.

### EXAMPLE 2

### Preparation of 2-Dimethylcyclohexylsilyl-1,4-bis(bromomethyl)benzene (6)

2-dimethylcyclohexylsilyl-p-xylene (7.0 g, 28.4 mmol) in carbon tetrachloride (80 ml) was added with N-bromosuccinimide (10.7 g, 59.6 mmol) and then with benzoyl peroxide as an initiator. The reaction mixture was heated to reflux at 80° C. for 4 hours under nitrogen atmosphere. The completion of the reaction was indicated by the appearance of succinimide on the surface of the reaction solution. The organic layer was washed with water and brine, and dried over anhydrous magnesium sulfate. After the solvent was evaporated, a yellowish oil was obtained. Chromatography on a silica column using hexane as eluent gave the brominated product as a colorless oil (yield: 47%, 5.4 g).

¹H-NMR (CDCl₃, ppm): 7.42-7.24 (m, 2H), 7.26-7.22 (m, 1H), 4.58 (s, 2H), 4.47 (s, 2H), 1.71-1.59 (m, 5H), 1.27-0.90 (m, 6H); ³C-NMR (CDCl₃, ppm): 143.41, 138.36, 136.70, 135.84, 132.07, 130.22, 41.44, 40.41, 28.11, 27.50, 27.31, 14.11, −4.11. Anal. Calcd for C₁₆H₂₄Br₂Si: C, 47.54; H, 5.98. Found: C, 47.88; H, 5.78.

### EXAMPLE 3

### Preparation of 2-Dimethylphenylsilyl-p-xylene (7)

2-bromo-p-xylene (10.0 g, 54.0 mmol) in absolute THF was activated with 5 mol % 1,2-dibromoethane at 80° C., and slowly added with clean magnesium turnings (2.23 g, 92.0 mmol). When the magnesium turnings were completely consumed, chlorodimethylphenylsilane (15.4 ml, 92.0 m mol) was added thereto. The reaction mixture was heated to reflux for 6 hours, and the reaction was quenched with dilute hydrochloric acid solution. THF layer was separated and washed several times with water, while the solvent was removed using a rotary evaporator. The residue was vacuum distilled, producing a colorless liquid product (yield: 48%, 6.2 g).

¹H-NMR (CDCl₃, ppm): 7.52 (m, 2H), 7.36 (m, 4H), 7.14 (d, 1H), 7.08 (d, 1H), 2.35 (s, 3H), 2.24 (s, 3H), 0.60 (s, 6H); ¹³C-NMR (CDCl₃) 140.90, 139.05, 135.99, 135.80, 133.94, 133.53, 130.28, 129.83, 128.83, 127.76, 22.60, 21.08, −1.36.

Anal. Calcd for C₁₆H₂₀Si: C, 79.93; H, 8.38. Found: C, 78.80; H, 8.09.

### EXAMPLE 4

### Preparation of 2-Dimethylphenylsilyl-1,4-bis(bromomethyl)benzene (8)

2-dimethylphenylsilyl-p-xylene (7.0 g, 29.0 mmol) in carbon tetrachloride (100 ml) was added with N-bromosuccinimide (11.5 g, 64.0 mmol) and then with benzoyl peroxide as the initiator. The reaction mixture was heated to reflux at 80° C. for 4 hours under nitrogen atmosphere. The completion of the reaction was indicated by the appearance of succinimide on the surface of the reaction solution.

The organic layer was washed with water and brine, and dried over anhydrous magnesium sulfate. After evaporation of the solvent, a yellowish oil was obtained. Chromatography on a silica column using hexane as eluent gave the brominated product as a colorless oil (yield: 52%, 6.0 g).

¹H-NMR (CDCl₃, ppm): 7.51-7.42 (m, 5H), 7.38-7.24 (m, 3H), 4.46 (s, 2H), 4.36 (s, 2H), 0.64 (s, 6H); ³C-NMR (CDCl₃, ppm): 143.82, 137.76, 136.95, 133.93, 131.68, 130.87, 129.79, 129.45, 128.85, 128.16, 33.62, 33.14, −1.05. Anal. Calcd for C₁₆H₁₈Br₂Si: C, 48.26; H, 4.56. Found: C, 47.88; H, 4.78.

### EXAMPLE 5

### Polymerization I (Preparation of DMCyS-PPV)

1) Synthesis of Precursor Polymer 11 (Halogen Precursor Route)

In absolute THF (3 ml) cooled with acetone/ice bath under nitrogen, 2-dimethylcyclohexylsilyl-1,4-bis(bromomethyl)benzene (0.5 g, 1.23 mmol) obtained from the above example 2 was dissolved and stirred. Potassium tert-butoxide (131 mg, 1.10 mmol) in absolute THF (3 ml) was added to the above solution, to produce a viscous sky-blue solution. After 10 minutes, the reaction mixture was allowed to warm to room temperature and stirred for 2 hours. Such a reaction mixture was added dropwise to ice-cooled methanol (25 ml), to precipitate a polymer 11, which is a precursor polymer of DMCyS-PPV. The mixture was filtered and the residue, polymer 11, was dried under vacuum. The residue was dissolved in anhydrous chloroform, and the polymer was precipitated again by addition with excess methanol. After the mixture was filtered, the residue was collected. Such a procedure was repeated twice more, to obtain a sky-blue solid polymer 11 (yield: 45%, 0.18 g).

¹H-NMR (CDCl₃, ppm): 7.79-6.65 (br m, vinyl H and Ar H), 5.75-4.95 (br m, CHBr), 3.71-2.89 (br m, ArCH₂), 2.35-0.80 (br m, CH and CH₂ of cyclohexyl), 0.75˜-0.17 (br m, —Si(CH₃)₂).

2) Preparation of DMCyS-PPV (Gilch Polymerization Route)

The monomer 6 (0.5 g, 1.23 mmol), resulting from the above example 2, was dissolved in THF (30 ml) with tert-butylbenzyl bromide (29 mg, 0.123 mmol) as an end cap, and cooled to 0° C. As the initiator, 3.69 mmol potassium tert-butoxide (1 M in THF) was added thereto. The reaction solution progressively turned to green, and was viscous during the addition. The highly viscous solution was stirred at 0° C. for 3 hours, and slowly added to methanol (300 ml) with vigorous stirring. The resulting yellow precipitate was collected, dissolved in chloroform and reprecipitated in methanol/acetone (1/1) twice more. Impurities and polymers having low molecular weight were extracted from methanol using a Soxhlet extractor for 24 hours, and the residue was vacuum dried at 20° C., to give a final yellow fibrous product (yield: 57%, 0.17 g).

FT-IR (KBr) max/cm⁻¹: 3059, 2924, 2845, 1489, 1449, 1252, 1142, 1102, 1070, 1000, 960, 889, 842, 802, 763, 645. ¹H-NMR (CDCl₃, ppm): 7.88-6.80 (br m, 5H, Ar H and vinylic H), 1.98-1.33 (br s, 5H, CH and CH₂ of cyclohexyl), 1.31-0.78 (br s, 6H, CH₂ of cyclohexyl), 0.71-0.40 (br s, 6H, —Si(CH₃)₂). Anal. Calcd for (C₁₆H₂₂Si)ₙ: C, 79.25; H, 9.16. Found: C, 79.01; H, 9.78.

### Molecular Weight Determination

The luminescent polymer DMCyS-PPV, produced by Gilch polymerization procedure, was determined for its molecular weight using gel permeation chromatography (eluent: THF, standard: polystyrene). As the result, the number average molecular weight (Mₙ) was 351,000 (M_{w}/Mₙ=4.1), which was much higher than that of conventional other alkylsilyl substituted PPVs.

### EXAMPLE 6

### Polymerization II (Preparation of DMPS-PPV)

1) Synthesis of Precursor Polymer 12 (halogen precursor route)

Potassium tert-butoxide (134 mg, 1.13 mmol) in absolute THF (3 ml) was added to a stirred solution of 2-dimethylphenylsilyl-1,4-bis(bromomethyl)benzene (0.5 g, 1.26 mmol) obtained from the above example 4 in absolute THF (3 ml) cooled with acetone/ice bath under nitrogen, to produce a viscous sky-blue solution. After 10 minutes, the reaction mixture was allowed to warm to room temperature and stirred for 2 hours. Such a reaction mixture was added dropwise to ice-cooled methanol (25 ml), to precipitate a polymer 12, which is a precursor polymer of D MPS-PPV. The polymer 12, remaining after the reaction mixture was filtered was dried under vacuum, and dissolved in dry chloroform and again precipitated with excess methanol. After the mixture was filtered, the residue was collected. Such a procedure was repeated twice more, to obtain a sky-blue solid polymer 12 (yield: 50%, 0.20 g).

¹H-NMR (CDCl₃, ppm): 7.67-6.69 (br m, ArH and vinyl H), 6.12-5.75, 5.65-5.32, 5.25-4.85, 4.84-4.61 (br m, CHBr), 3.67-2.86 (br m, ArCH₂), 0.89-0.25 (br m —Si(CH₃)₂).

2) Preparation of DMPS-PPV (Gilch Polymerization Route)

The monomer 8 (0.5 g, 1.26 mmol), resulting from the above example 4, was dissolved in THF (30 ml) with tert-butylbenzyl bromide (30 mg, 0.126 mmol) as the end cap, and cooled to 0° C. As the initiator, 3.78 mmol potassium tert-butoxide (1 M in THF) was added thereto. The reaction solution gradually turned to green, and was viscous during the addition. The highly viscous solution was stirred at 0° C. for 3 hours, and slowly added to methanol (300 ml), with vigorous stirring. Thereby, a yellow precipitate was collected, dissolved in chloroform and reprecipitated twice more in methanol/acetone (1/1) solution. Impurities and polymers having low molecular weight were extracted from methanol using the Soxhlet extractor for 24 hours, and the residue was vacuum dried at 20° C., producing a final yellow fibrous product (yield: 60%, 0.18 g).

FT-IR (KBr) max/cm⁻¹: 3074, 3043, 3011, 2956, 1481, 1426, 1252, 1110, 1063, 961, 905, 810, 771, 731, 692, 645, 582, 463. ¹H-NMR (CDCl₃, ppm): 7.98-6.82 (br m, 10H, Ar H and vinylic H), 0.98-0.10 (br s, 6H, −Si(CH₃)₂). Anal. Calcd for (C₁₆H₁₆Si)ₙ: C, 81.28; H, 6.84. Found: C, 80.88; H, 6.78.

### Molecular Weight Determination

The luminescent polymer DMPS-PPV, produced by Gilch polymerization route, was determined for its molecular weight using gel permeation chromatography (eluent: THF, standard: polystyrene). As the result, the number average molecular weight (Mn) was 292,000 (PDI(M_{w}/Mₙ)=3.9), which was much higher than that of conventional alkylsilyl substituted PPVs (see, Table 1).

### TEST EXAMPLE 1

### Mechanical Properties

### Thermal Stability

DMCyS-PPV and DMPS-PPV, the luminescent polymers produced by Gilch polymerization, were measured for their thermal stability through well-known thermo gravimetric analysis. As shown in the following Table 1, the polymers exhibited a weight loss of less than 5% at about 400° C. Specifically, each 5% weight loss temperatures (TID) of the above polymers were 428° C. and 435° C. Thereby, it appeared that the polymers of the present invention are thermally stable, compared to alkylsilyl substituted PPVs (see, FIG. 3)

### Glass Transition Temperature

Mechanical strength of the luminescent polymers was measured by well-known differential scanning calorimetry (DSC) measurements under a nitrogen atmosphere (see, FIG. 4). The DSC curves showed glass transition temperatures (T_{g}) of 126° C. for DMCyS-PPV and 127° C. for DMPS-PPV. These values were higher compared to those of well-known alkoxy substituted MEH-PPV (65° C.) and normal alkylsilyl substituted PPVs (60-80° C.), and were even comparable to those of polyfluorene derivatives (75-125° C.).

TABLE 1
Polymerization Result and Thermal Properties of Polymers

| | Yield | | | | | |
|---|---|---|---|---|---|---|
| Polymer | (%) | Mₙ | M_{w} | PDI | T_{g}(° C.) | T_{ID}(° C.) |
| DMCyS- | 57 | 3.5 × 10⁵ | 1.4 × 10⁶ | 4.10 | 126 | 428 |
| PPV | | | | | | |
| DMPS- | 60 | 2.9 × 10⁵ | 1.1 × 10⁶ | 3.88 | 127 | 435 |
| PPV | | | | | | |

### TEST EXAMPLE 2

### Photoluminescence Properties

1) UV Absorption Spectrum

DMCyS-PPV and DMPS-PPV obtained by Gilch polymerization, were measured for UV absorption spectra in solution, and as film samples thereof, according to a known method.

As the solution samples, these polymers were completely dissolved in chloroform and used, while the polymers fabricated as thin films were used as the film samples (FIG. 5). The maximum UV absorptions of DMCyS-PPV and DMPS-PPV in solution appeared at 414 nm and 418 nm, respectively. Meanwhile, the absorption maxima of the film samples were bathochromically shifted compared to the corresponding solution samples.

It was observed that the maximum absorption peak of DMPS-PPV film was shifted to longer wavelengths, compared to that of DMCyS-PPV film. This indicates that π-electron delocalization of DMCyS-PPV is interrupted to a greater extent than that in DMPS-PPV.

2) Photoluminescence (PL) Spectrum

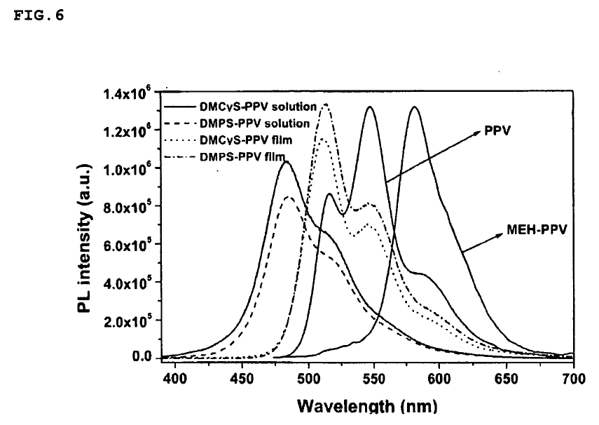

With reference to FIG. 6, there is shown photoluminescence (PL) spectra recorded using excitation wavelengths corresponding to the maximum absorption wavelength of each polymer in solution and film phase. The PL spectra of DMCys-PPV and DMPS-PPV in solution exhibit maximum emission peaks at 491 and 493 nm, respectively. The spectra of the film samples resemble those of the corresponding solutions but are shifted to longer wavelengths. Also, DMPS—PPV exhibits almost the same emission profile as that of DMCyS-PPV, but is slightly shifted to long wavelengths (maximum emission peaks: DMCyS-PPV (about 510 nm) and DMPS-PPV (about 513 nm), shoulder peaks: DMCyS-PPV (about 545 nm) and DMPS-PPV (about 547 nm)). It can be seen that the above result accords with that of the UV absorption spectrum.

As shown in FIG. 6, compared to PL spectra of known PPV and alkoxy substituted MEH-PPV, it appears that the luminescent polymers of the present invention are further shifted to shorter wavelengths.

3) Measurement of Quantum Efficiency

The quantum efficiency of each luminescent polymer in chloroform solution was determined using a dilute quinine sulfate (1×10⁻⁵ M in 1 N H₂SO₄) as a standard, while the film efficiency was measured using an optically dense configuration and diphenylanthracene (dispersed in a PMMA film at a concentration of less than 10⁻³) as the standard.

The quantum yields of DMCyS-PPV and DMPS-PPV are shown as Φₛₒₗ=0.88 and 0.86 in the solution phase, and Φ_{film}=0.82 and 0.83 in the film phase, which are much higher than those of conventional other PPV derivatives. The results are shown in Table 2, below.

TABLE 2
UV and PL Spectrum Result and Quantum Efficiency

| | λₘₐₓ(UV, nm) | | λₘₐₓ(PL, nm) | | PL Effi.(Φ) | |
|---|---|---|---|---|---|---|
| Polymer | Liq. Ph. | Sol. Ph. | Liq. Ph. | Sol. Ph. | Liq. Ph. | Sol. Ph. |
| DMCyS- | 414 | 420 | 491(515) | 510(545) | 0.88 | 0.82 |
| PPV | | | | | | |
| DMPS- | 418 | 422 | 493(517) | 513(547) | 0.86 | 0.83 |
| PPV | | | | | | |

### TEST EXAMPLE 3

### Electrochemical Properties

1) Electrochemical Properties

To determine the electrochemical properties, well-known cyclic voltammetry (CV) was performed on a solution of 0.1 M tetrabutylammonium tetrafluoroborate (Bu₄NBF₄) (solvent: acetonitrile) at a scan rate of 50 mV/s at room temperature under the protection of argon. A platinum electrode was coated with the luminescent polymer film of the present invention and used as the testing electrode. As the counter electrode and the reference electrode, a platinum wire and a silver/0.10 M silver nitrate electrode were used, respectively.

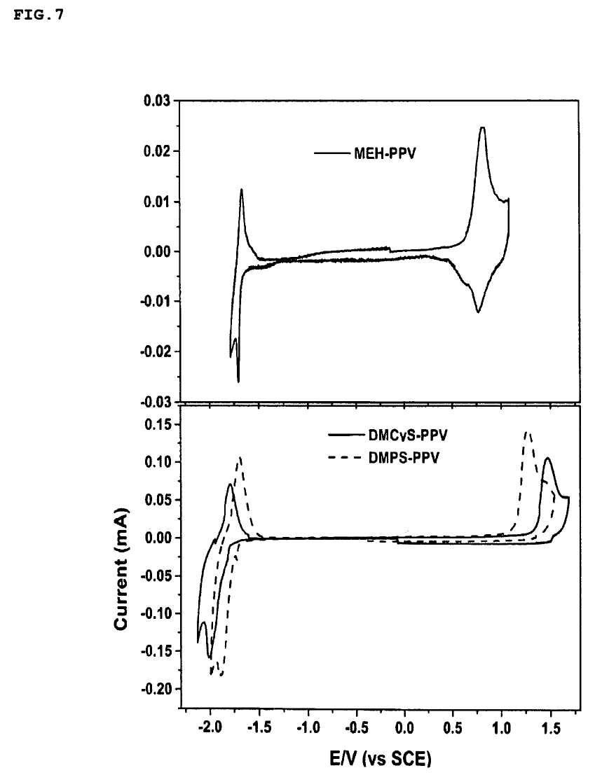

The results are shown in FIG. 7. During the cathodic scan, DMPS-PPV exhibited reversible n-doping. A cathode peak potential (E_{pc}) and an anode peak potential (Eₚₐ) were −1.68 V and −1.89 V, and the reduction onset potential (E_{red}) of the n-doping process occurred at about −1.75 V. DMCyS-PPV showed similar peaks and onset potentials to those of DMPS-PPV, but with a slightly lower onset potential for reduction, −1.81 V. This means that DMCyS-PPV has a lower electron affinity than DMPS-PPV for accepting electrons from the cathode in the electroluminescence device.

In addition, during the anodic scan, both of DMCyS-PPV and DMPS-PPV exhibited similar irrevisible p-doping. As such, peak potentials were 1.47 and 1.27 V, and the onset potentials of oxidation (Eₒₓ) were 1.25 V and 1.16 V. DMCyS-PPV had somewhat higher oxidation onset potential value.

The luminescent polymers have much lower peak currents for cathodic reaction when compared with conventional alkoxy substituted MEH-PPV. This result indicates that the inventive polymers have a greater potential for accepting or transporting electrons than alkoxy substituted PPV derivatives.

The solid phase IP (E_{HOMO}) and EA (E_{LUMO}) can be obtained from the oxidation and reduction onset potentials (see, Table 3) (E_{HOMO} and E_{LUMO} mean energy of HOMO and LUMO under vacuum). According to the following Table 3, the inventive luminescent polymers have higher EA values that those of other PPV derivatives, since electron injection from a metal electrode acting as the cathode is much easier than hole injection.

TABLE 3
Electrochemical Properties and Energy Level

| | n-doping (V) | | | p-doping (V) | | | Energy Level (eV) | | |
|---|---|---|---|---|---|---|---|---|---|
| Polymer | Eₒₙₛₑₜ | Eₚₐ | E_{pc} | Eₒₙₛₑₜ | Eₚₐ | E_{pc} | IP | EA | Band Gap |
| DMCyS- | −1.81 | −1.77 | −2.01 | 1.25 | 1.47 | | −5.64 | −2.58 | 3.06 |
| DMPS-PPV | −1.75 | −1.68 | −1.89 | 1.16 | 1.27 | | −5.55 | −2.64 | 2.91 |
| MEH-PPV | −1.57 | −1.66 | −1.70 | 0.55 | 0.82 | 0.77 | −4.94 | −2.82 | 2.12 |

As for electroluminescence devices, conventional PPV derivatives (alkylsilyl or alkoxy substituted PPV) usually suffer from accelerated hole injection characteristics and imbalance of injected hole and electron upon use of an air-stable metal cathode. However, the luminescent polymers of the present invention with retarded hole injection show more balanced hole and electron injection, thereby fabricating an improved electroluminescence device.

2) Electroluminescence (EL) Spectrum

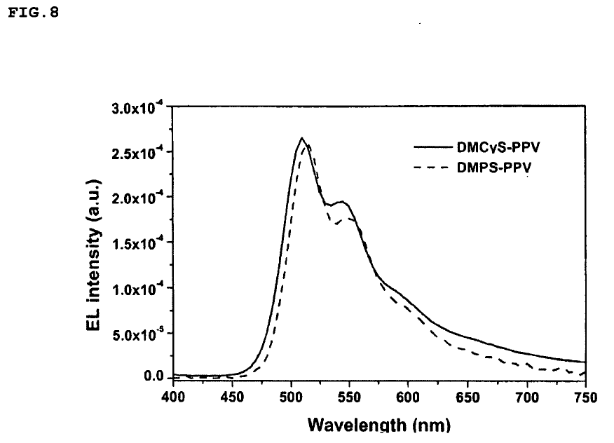

Referring to FIG. 8, there is shown an electroluminescence (EL) spectrum obtained from the device configuration comprising ITO/polymer light-emitting layer/Al electrode layer. DMCyS-PPV and DMPS-PPV exhibit emission bands at 510 nm and 515 nm, respectively, which correspond to visible green light.

3) Voltage-Current and Luminance Density-Voltage Characteristics

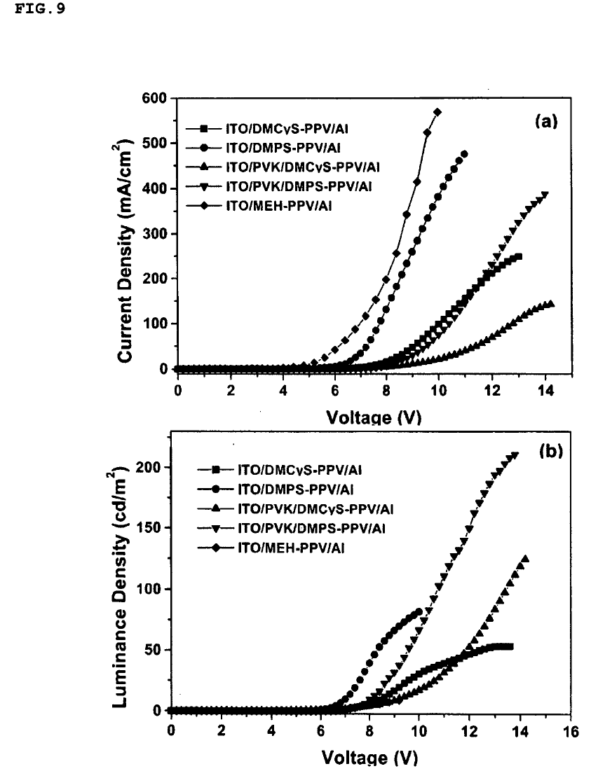

In FIGS. 9a and 9b, there are shown a current-voltage curve and a luminance density-voltage curve of the single layer EL device comprising an ITO/polymer light-emitting layer/Al electrode layer and the double layer EL device comprising an ITO/PVK/polymer light-emitting layer/Al electrode layer. All polymer film layers were 80 nm thick.

As can be seen in FIGS. 9a and 9b, DMCyS-PPV and DMPS-PPV in the single layer EL device showed maximum luminance values of 54 and 91 cd/m² at 11 and 13 V, respectively. Also, as for DMPS-PPV, the external quantum efficiency and the power efficiency reached 0.025% and 0.047 lm/W, which were much higher than those of MEH-PPV (external efficiency: 2×10⁻³%). As well, DMCyS-PPV and DMPS-PPV were 7 V and 6 V, respectively, which were relatively lower turn-on voltages than octylsilyl-substituted DMOS-PPVs (≧10 V).

The double layer EL device was improved in its performance. The double layer EL device had a turn-on voltage 2 or 3 V higher than that of the single layer EL device, but was far superior in maximum brightness, external quantum efficiency and power efficiency.

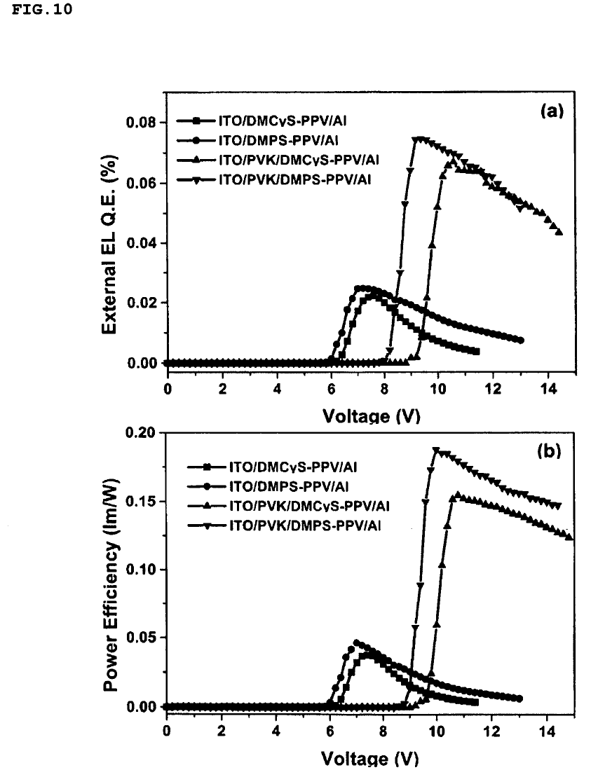

The device comprising the ITO/PVK/DMPS-PPV/Al electrode layer reached a maximum brightness of 220 cd/m² at 14 V and showed 0.075% and 0.187 lm/W for the external quantum efficiency and power efficiency, respectively. The external quantum efficiency and power efficiency curves of the EL device provided with single layer and double layer are shown in FIG. 10.

4) Multi-Layer Electroluminescence Device

In order to improve performance of the EL device, a 30 nm thick PEDOT:PSS layer was sandwiched between the ITO and the PVK layer, and a 2 nm thick LiF layer was inserted between the DMPS-PPV and Al layer, to fabricate a multi-layer electroluminescence device. The PEDOT:PSS layer is widely used as a hole injecting layer, and the LiF layer acts as an insulating layer.

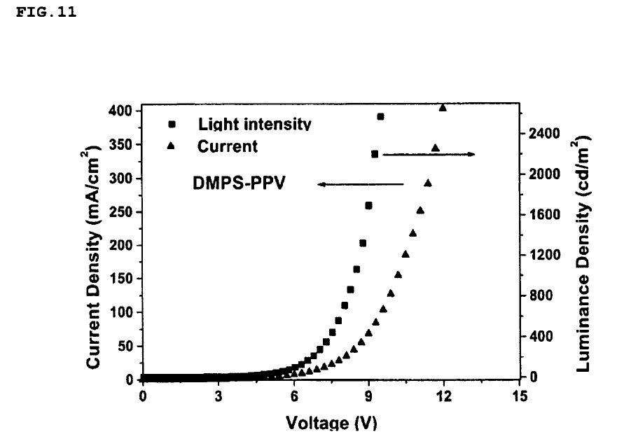

As seen in FIG. 11, maximum brightness of the multi-layer electroluminescence device is 2450 cd/m² at 370 mA/cm², with a turn-on voltage of 5 V.

As described above, it can be confirmed that the device applied with the luminescent polymers of the present invention is more excellent in its performance than conventional PPV derivative-applied devices.

### INDUSTRIAL APPLICABILITY

The luminescent polymers of the present invention exhibit excellent thermal properties and luminance efficiency, and also emit light in the green light wavelength range by electronic properties of a silyl substituent. Thus, the inventive polymers are very useful in the electroluminescence device materials.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A luminescent polymer represented by the following formula 1: 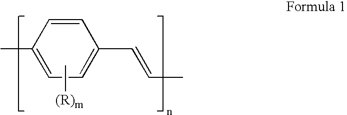
wherein R is a cyclohexyl or phenyl substituted silyl group; and m is an integer of 1-4:

2. The polymer as defined in claim 1, wherein the silyl group contains C1 to C20 linear or branched alkyl groups.

3. A method of producing a luminescent polymer represented by the formula 1, comprising the step of polymerizing a monomer compound represented by the following formula 2: 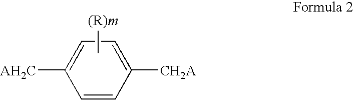
wherein R is a cyclohexyl or phenyl substituted silyl group; m is an integer of 1-4; and A is a halogen element.

4. The method as defined in claim 3, wherein the polymerizing step is performed by halogen precursor route or Gilch polymerization route.

5. The method as defined in claim 3, wherein A is bromine.

6. An electroluminescence device comprising a polymer light-emitting layer formed with the luminescent polymer of claim 1.

7. The device as defined in claim 6, wherein a semitransparent electrode layer, the polymer light-emitting layer and a metal electrode layer are successively formed on a substrate.

8. The device as defined in claim 6, wherein a semitransparent electrode layer, a hole injecting layer, the polymer light-emitting layer, an electron injecting layer and a metal electrode layer are successively formed on a substrate.

9. The device as defined in claim 8, wherein the hole injecting layer is poly(styrenesulfonic acid) doped poly(3,4-ethylenedioxythiophene).

10. The device as defined in claim 8, wherein the electron injecting layer is formed with an alkali metal compound.

11. The device as defined in any one of claims 6 to 10, wherein the polymer light-emitting layer is formed by blending the luminescent polymer with an electron or a hole transporting polymer.

12. The device as defined in claim 11, wherein the hole transporting polymer is poly(9-vinylcarbazol).
